(19) United States
(12) Patent Application Publication
(10) Pub. No.: US 2005/0241353 A1
(43) Pub. Date: Nov. 3, 2005

(54) Interchangeable key system

(76) Inventor: Paul Forrest Moening, Los Angeles, CA (US)

Correspondence Address: Paul F. Moening, 9906 Girla Way, Los Angeles, CA, 90064, US

(21) Appl. No.: 10/973,648

(22) Filed: Oct. 26, 2004

Related U.S. Application Data
(60) Provisional application No. 60/567,314, filed on Apr. 30, 2004.

(51) Int. Cl. E05B 19/04

(52) U.S. Cl. 70/408

(57) ABSTRACT

An interchangeable key system having a non-spheroidal head with a one-piece construction, where the head includes a side surface that spans the periphery, a top end, a bottom end that is opposite the top end, and a bore positioned within the side surface and at the bottom end. The key system also includes a blank having a blade at a distal end and a projection at a proximal end; where the blade is adapted for insertion into a lock, and at least a portion of the projection is adapted for insertion into the bore. The key system also includes means for removably connecting the blank and the head together, such that the blank is generally fixed relative to the head when the two are connected.

### CROSS-REFERENCE TO RELATED APPLICATION(S)

This application claims the benefit of provisional patent application Ser. No. 60/567,314, filed Apr. 30, 2004.

### FIELD OF THE INVENTION

This invention relates to devices for use in connection with keys such as those typically used for operating residential and commercial door locks, car locks and car ignitions, and is particularly, but not exclusively, concerned with a system for flexibly ornamenting that portion of a key commonly known as the head, the bow, or the tab.

### BACKGROUND OF THE INVENTION

Keys, as commonly used for operating locks installed on home and office doors and for operating automobiles, are ubiquitous and come in many types, but generally are unadorned and have quite similar appearances. The relatively similar and generic appearance of keys often results in delays in ascertaining the correct key for a lock when there are more than a few keys on a keychain or other key holder. Difficulty in locating a particular key results in wasted time and needless frustration, and can also jeopardize safety.

In the marketplace, although there are a number of add-on devices for differentiating keys, there is little available in terms of design-oriented or fashionable key designs. Some design-conscious consumers desire keys that are stylish, are unique, and that satisfy their need for self-expression. However, due to how often it is necessary to change keys due to changing of locks, moving residences, or changing vehicles, there is a disincentive to purchase anything but inexpensive, unadorned keys. That is because the average consumer would not want to pay a premium for an ornamented key that would eventually have to be discarded when the consumer moved residences, changed door locks or bought a new car. For ornamented key styles to be economically practical from a consumer's perspective, there is a need for a mechanism and system to provide for interchangeability of the key or the key blade from the ornamented key part, so that the ornamented key part can be kept indefinitely and fitted with new blades.

Several types of multi-part or hinged ornamental tab devices have been proposed, in which a key with a standard type key head is enveloped by a hinged or box-like case, or sandwiched between plates. For example, U.S. Pat. No. 4,826,002 proposes a number of configurations of a two-part or hinged case that envelops a standard tabbed key. That design relies on intake walls, or sponge-like inserts, to lock the shaft in place so as to prevent rotary movement of the shaft relative to the case. Consequently, if the key used is of a thickness that is less than the opening in the peripheral wall of the case, there could be undesired displacement or play between the shaft and the case. Similarly, U.S. Pat. Nos. 4,349,975, 4,102,166, and 2,759,280 disclose variants of a sandwich-construction key bow cover, which although utilitarian for means of providing enhanced identification capabilities for keys, fall short of providing a refined aesthetic finish to a key. Other multi-piece constructions are disclosed in U.S. Pat. Nos. 4,901,548, 5,383,345, and 6,651,470, which require relatively complicated construction, and have limited flexibility for the shape, ornamentation, and interchangeability of the key head.

### SUMMARY OF THE INVENTION

Shortcomings of prior key systems may be overcome with an embodiment of the present invention.

One embodiment of the present key system has a non-spheroidal head with a one-piece construction, where the head includes a side surface that spans the periphery, a top end and a bottom end that is opposite the top end, and a bore positioned within the side surface and at the bottom end. The key system also includes a blank having a blade at a distal end and a projection at a proximal end; where the blade is adapted for insertion into a lock, and at least a portion of the projection is adapted for insertion into the bore. The key system also includes means for removably connecting the blank and the head together, such that the blank is generally fixed relative to the head when the two are connected.

### BRIEF DESCRIPTION OF THE DRAWINGS

FIG. 1A is a partially exploded perspective view of an exemplary key system;

FIG. 1B is a perspective view of the key system shown in FIG. 1A;

FIG. 2 is a partially exploded perspective view of an exemplary key system;

FIG. 3 is an exploded perspective view of an exemplary key system;

FIG. 4 is an exploded perspective view of an exemplary key system;

FIG. 5 is an exploded perspective view of an exemplary key system;

FIG. 6 is a perspective view of an exemplary key system;

FIG. 7 is an exploded perspective view of an exemplary key system; and

FIG. 8 is an exploded perspective view of an exemplary key system.

### DETAILED DESCRIPTION OF THE INVENTION

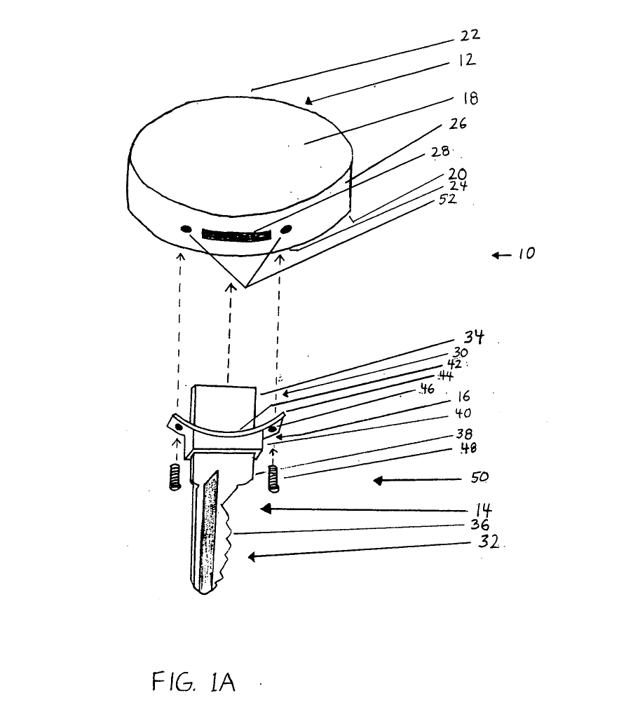

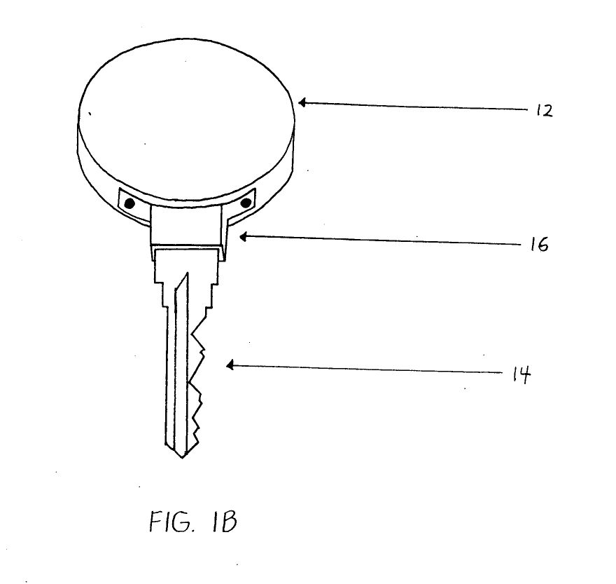

FIGS. 1A and 1B show a partially exploded perspective view, and a perspective assembled view, respectively, of an exemplary interchangeable key system 10. The key system 10 generally comprises a head 12, a blank 14, and a collar 16.

The head 12 is shown having a single-piece construction with a front surface 18, a back surface 20 facing opposite the front surface, a top end 22, and a bottom end 24 opposite the top. In the configuration of the head depicted, a side surface 26 spans the periphery of the head and is generally disposed between the front and back surfaces. The head also comprises a bore 28, which is configured to receive a portion of the blank 14 and/or a portion of the collar 16, thereby allowing the head, the blank, and the collar to be attached in a manner that creates a single key that can cooperatively engage with a corresponding lock. The bore is shown positioned within the side surface 26 and at the bottom end 24 of the head. The head can be formed in various utilitarian shapes and configurations, particularly non-spheroidal shapes that promote enhanced gripping and provide reduced volume and bulk. Likewise, the head can be made from any suitable materials that allow it to withstand the ordinary uses of a key, including metal, alloy, wood, glass, stone, plastic, rubber, resin, enamel, composite, fiber-reinforced material, ivory, bone, leather, or any combination of suitable materials. Further, the front and/or rear surfaces of the head can accommodate any desired design, image, or texture to achieve a desired ornamental and stylish appearance.

The blank 14 is configured to be removably attached to the head. The blank has a proximal end 30 and a distal end 32. The proximal end includes a projection 34, which is designed to fit within the collar 16 and, in this embodiment, to extend past the collar and fit within the bore of the head. The distal end comprises a conventional blade portion 36, which is the portion of a key that engages the locking mechanism of a lock. The blade portion can have any desired profile, configuration or features, including but not limited to, the profiles and configurations found on the blades of the most common brands of key blanks found in the marketplace, such as those sold by Kwikset, Schlage, and Titan. The blank shown also includes a shoulder 38, which is positioned between the proximal and distal ends, and at the end of the blade portion.

The collar 16 is configured to attach to the blank 14 and the head 12, thereby connecting the blank to the head. The collar can have any desired shape and configuration, but is shown having a shape that conforms to the bottom end of the head. The collar generally comprises a hollowed neck 40 that is adapted to receive the projection 34 of the blank, and a support base 42 that extends from the neck and is designed to attach the collar to the head. The support base is shown having a pair of winged tabs 44, each having a hole 46 that is adapted to receive a fastener 48. The collar is shown fixedly attached to the blank, such that an integral collared key blank 50 is depicted. The attachment between the collar and blank can be achieved by any suitable means, including adhesives, interference fit, welding, soldering, etc.

The collared key blank 50 is attached to the head by inserting the projection 34 into the bore 28 of the head until the winged tabs of the collar rest against the side surface of the head. The fasteners 48 are then inserted through the holes 46 in each of the winged tabs and are received within a pair of retaining holes 52 that are positioned on opposite sides of the bore. The fasteners are shown as screws that are threaded into the receiving holes in the head. Upon securing the fasteners into the head, the blank, the collar, and the head are integrally formed as key system 10.

The use of the collar allows a single-sized head 12 to be used with different sized blanks. Because blanks and blades of various profiles and manufacturers differ in thickness, not all blanks, which are typically stamped out of metal of uniform thickness, would fit snugly within the bore of the head. The collar allows for the various sized blanks to be secured within the collar and firmly connected to the head. The collar would also cover any spaces or gaps that may exist between the projection of the blank and the bore when the projection is inserted into the bore. Moreover, the collar can provide a more streamlined and polished appearance, and can be ornamented in its shape, styling and material of composition. As explained below, however, the key system 10 can be beneficially used without the collar, particularly when the bore and the projection are dimensioned so that the projection fits snugly within the bore.

When a user of the key system needs to change their key for whatever reason (such as moving residences, changing their locks, etc.), the key system 10 allows for a new key blank to be used, while allowing the user to keep and re-use their key head. The integral collared key blank 50 can be removed from the head, and a new collared key blank, having a different key blade configuration designed to fit the user's new lock, can be attached. Therefore, the user can customize their key head and not lose the investment in the head or the sentimental value that has attached to the head.

The key blank projection within the bore provides additional attachment stability within the system. The projection can be configured to fit snugly within the bore. Further, the collar can also be configured to have its own projection that extends in a direction opposite to the neck and outward from the support surface. In such a configuration, the neck of the collar would be fashioned with a terminated shaft, rather than a shaft running entirely through the neck, as in the prior alternative. The blank projection, then, would be fitted into the neck of the collar and attached. The collar projection would then be fitted into the bore of the head and the collar attached to the head. Alternatively, different sized blanks could be used with a standardized bore size and any differences in size between the blank and bore could be filled by use of a sleeve or spacer(s). Or, the blanks could be manufactured with a uniform projection dimension and thickness that is designed to specifically fit the dimensions of the standardized bore. Thus, the relative configurations and uses of the collar and the blank can be varied to fit a standardized head and to accommodate the desires of different users and manufacturers without departing from the scope of the invention.

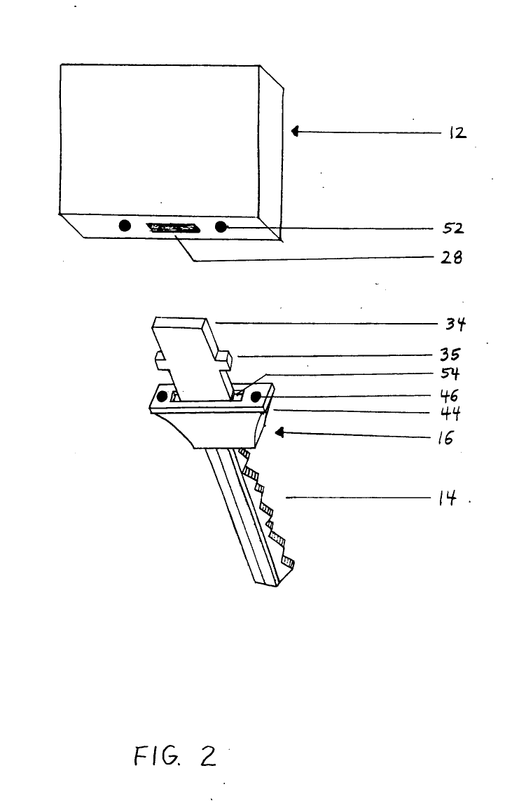

FIG. 2 shows a perspective partially exploded view of another exemplary embodiment of the exemplary key system. In this embodiment, the collar has been altered slightly from the first embodiment. Key head 10 is constructed with a bore 28 through one end. Specialized key blank 14 is formed with a projection 34, and stubs 35. Although not required, projection 34 would typically have a cross sectional profile that is substantially of the same shape and dimension as bore 28, so that projection 34 will fit snugly into the bore when it is thereby inserted (possibly with the addition of a sleeve or spacers). Collar 16 is fashioned having one or more winged tabs 44 (shown in FIG. 2 with two), with each winged tab fashioned with a winged tab hole 46. Aside from minor styling differences, this collar deviates from the collar shown in the prior embodiment in that it has a stub slot 54, which is designed to receive stubs 35 when the collar is fitted over key blank 14, and exert securing pressure on the key blank. Collar 16 is fixed to key head 12 by slipping the collar over key blank 14 until stubs 35 are nested in stub slot 54, then inserting projection 34 into bore 28 until collar winged tabs 44 are contacting key head 12, and winged tab holes 46 are aligned over retaining holes 52, and then inserting fasteners 48 through winged tab holes 46, and screwing them into retaining holes 52. In this configuration, stub slot 54 is pressing directly on stubs 35, pinning the stubs between the collar and key head 12, and thereby removably securing key blank 14 to key head 12. This embodiment could also be combined with the first embodiment: by also bonding the collar to the key blank, there would be enhanced strength and a redundant mechanism for attaching the key blank to the key head. Note that for a key blank to be compatible with collar 16, it need not have clearly delineated stubs, but rather could have a stepped increase in width at the appropriate point, or any other suitable configuration.

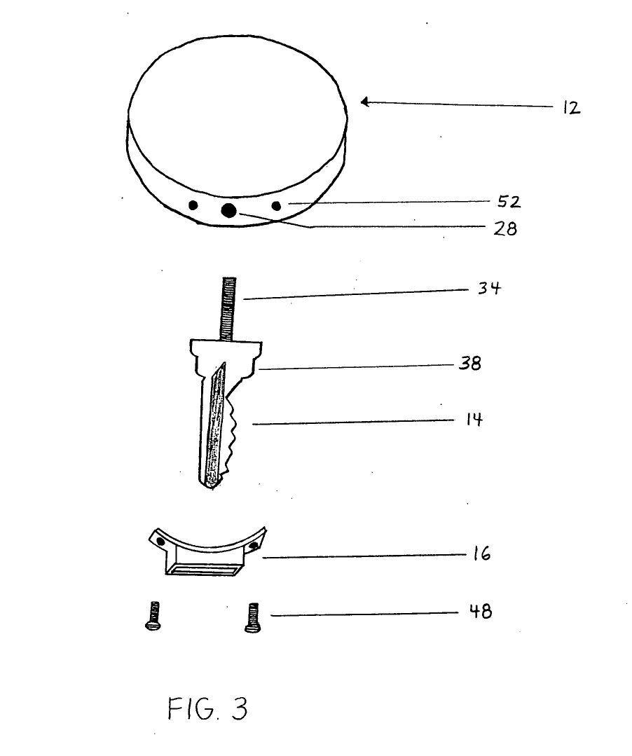

FIG. 3 shows a perspective exploded view of another exemplary embodiment of the key system. In this embodiment, the projection 34 of the blank is substantially cylindrical, similar to a threaded portion of a common machine screw, and designed to be threadedly engaged with the bore of the head. The projection can have any suitable shape and configuration for creating a mating engagement with the bore of the head, such as a more flattened form with screw threads along the edges. When the projection is threaded into the bore, the blank is generally secured to the head. The collar is fitted over the blank and secured to the head in the same manner as described above. The collar prevents the blank from rotating about its axis and moving relative to the head.

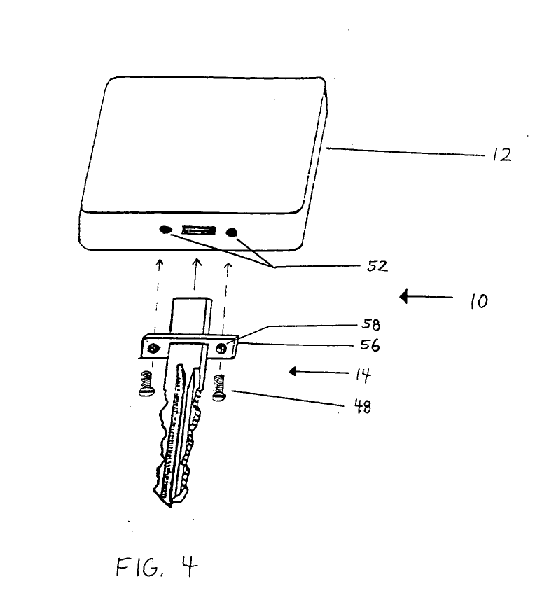

FIG. 4 shows a perspective exploded view of another exemplary embodiment of the key system 10. In this embodiment, there is no collar. Instead, the blank 14 comprises a pair of support arms 56 that each have support holes 58. The support arms rest along the side surface of the bottom end of the head when the projection of the blank has been inserted into the bore. The support holes 58 align over the retaining holes 52 of the head, and the support arms are connected to the head by fasteners 48. Thus, the blank and head are connected without use of a collar.

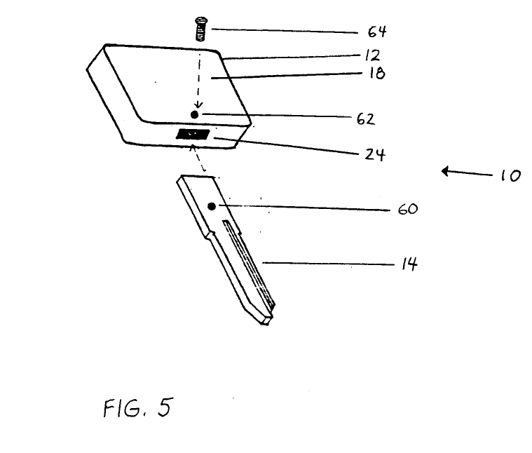

FIG. 5 shows a perspective exploded view of another exemplary embodiment of the key system 10. In this embodiment, the blank is again secured directly to the head without use of a collar. The projection of the blank comprises a mounting hole 60 which is designed to be inserted into the bore of the head. The head comprises one or more retention holes 62 in the front surface 18 and at the bottom end 24 near the bore. When the projection is inserted into the bore, the mounting hole and retention hole are aligned with one another, such that a retention fastener 64 can be inserted through the retention hole and mounting hole, thereby securing the blank within the head.

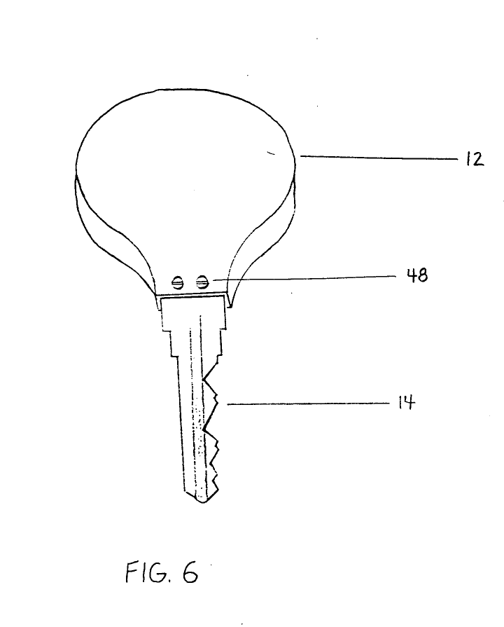

FIG. 6 shows a perspective view of another exemplary key system. The key system shown has the same general construction as shown in FIG. 5, except the head has a more rounded shape with an elongated bottom end, and the head has two retention holes, the blank has two mounting holes, and two retention fasteners were used to secure the blank within the head. The retention fastener is shown as a screw that threadedly engages the mounting hole of the blank; however, any suitable means for removably securing the projection within the head can be used, including but not limited to bolts, rivets, unthreaded holes and pins, etc.

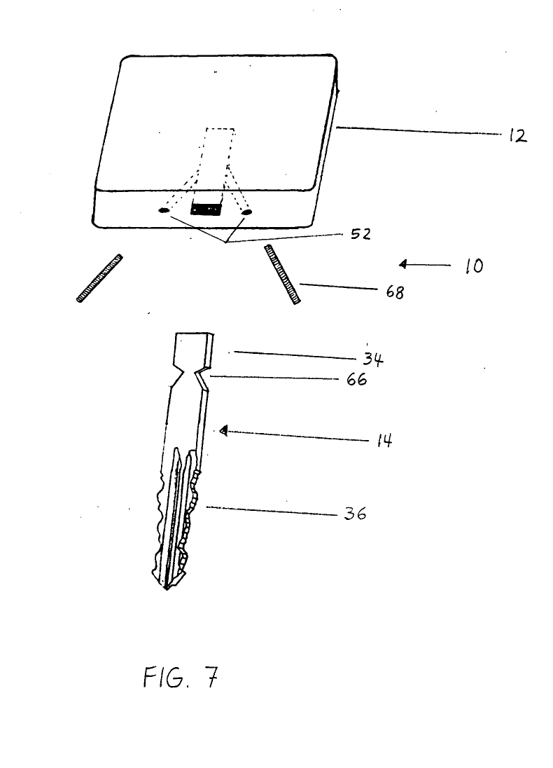

FIG. 7 shows an exploded perspective view of another exemplary key system 10. This embodiment does not use a collar to help secure the blank within the head. Instead, the retaining holes 52 in the head are milled at a diagonal angle, and the projection of the blank has a pair of notches 66. The projection and notches are designed for insertion into the bore, and the retention holes are adapted to each receive a threaded rod 68. When the threaded rods are inserted into the retention holes they engage the notches of the projection, thereby locking the projection within the bore. The notches have an alignment relative to the retention holes, such that after the notches and threaded rods are inserted into the head, side surfaces of the notches will be approximately perpendicular to the threaded rods. Other relative configurations between the projection, retention holes, and threaded rods can be used to removably secure the blank within the head.

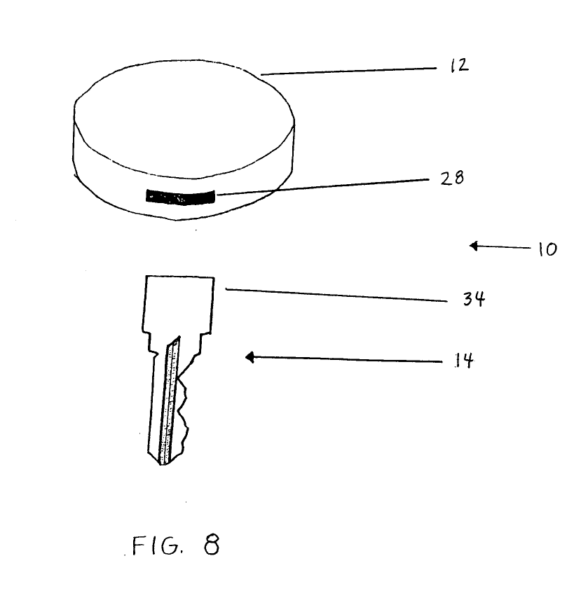

FIG. 8 shows an exploded perspective view of another exemplary embodiment of the key system 10. This embodiment presents an alternative means for removably securing the key blank to the key head. Key head 12 is constructed with a bore 28 through one end. The blank 14 is configured for insertion into the bore 28 of the head, and the removable attachment is achieved by coating the surface of the projection 34 and/or the interior of the bore 28 with an appropriate adhesive or glue, and any appropriate initiating and curing agents. To allow the head to be refitted with other key blanks, the adhesive should be capable of being debonded, such as by exposing the adhesive to localized elevated heat. One example of a suitable commercially available adhesive is Loctite 660, manufactured by Henkel Corporation, but an ordinary skilled artisan could readily identify a number of suitable adhesives. This embodiment, like the other above-described embodiments could also be fashioned with a collar, where the collar could provide additional strength and support, and/or provide decorative ornamentation.

In addition to the specific features and embodiments described above, it is understood that the present invention includes all equivalents to the structures and features described herein, and is not to be limited to the disclosed embodiments. For example, the shapes and configurations of the collar and the projection, as well as the bore, can be easily varied to suit users' preferences. A number of the specific means disclosed for achieving a removable attachment between the blank and the head can likewise be varied to include all known types of fasteners, adhesives, and other suitable combinations of devices and methods that can be used to achieve the desired attachment. The same flexibility for practicing the invention is true with respect to the particular materials and amount of materials used to construct the various portions of the system. Moreover, additional features can be added to the key system, such as including key ring attachments or apertures in the head to allow the key system to be placed on the user's key ring, or incorporating electronic chips or mechanisms, such as ignition transponder or anti-theft components for automobiles. Accordingly, individuals skilled in the art to which the present key system pertains will understand that variations and modifications to the embodiments described can be used beneficially without departing from the scope of the invention.

1. An interchangeable key system comprising:
a non-spheroidal head having a one-piece construction, wherein the head comprises a side surface that spans the periphery, a top end, a bottom end that is opposite the top end, and a bore positioned within the side surface and at the bottom end;
a blank comprising a blade at a distal end and a projection at a proximal end; wherein the blade is adaptable for insertion into a lock, and at least a portion of the projection is adapted for insertion into the bore; and
means for removably connecting the blank and the head together, such that the blank is generally fixed relative to the head when the two are connected.

2. The key system of claim 1 wherein the means for removably connecting the blank and the head together comprises a collar, wherein the collar comprises a hollowed neck adapted to receive the projection and a support base that extends from the neck and is adapted to attach to the head.

3. The key system of claim 2 wherein the head comprises at least one aperture positioned generally adjacent to the bore and the support base comprises at least one aperture that aligns with the aperture in the head when the projection is inserted into the bore, such that a fastener can be inserted through the aperture in the support base and into the head to secure the collar to the head.

4. The key system of claim 2 wherein the projection is secured within the hollowed neck by attachment means such as adhesive, interference fit, welding, soldering, and/or brazing.

5. The key system of claim 1 wherein the means for removably connecting the blank and the head together comprises an adhesive, wherein the adhesive contacts one or both of the projection and the bore, such that when the projection is inserted into the bore the adhesive retains the projection within the bore.

6. The key system of claim 1 wherein the means for removably connecting the blank and the head together comprises one or more fasteners.

7. The key system of claim 6 wherein the head further comprises a front surface and a back surface, and an aperture is positioned through the front surface near the bottom end, such that the aperture extends through a portion of the bore.

8. The key system of claim 7 wherein the projection is inserted into the bore a distance that extends at least as far as the aperture and the fastener is placed through the aperture such that the projection is secured within the bore.

9. The key system of claim 6 wherein the head further comprises one or more apertures positioned in the side surface and on opposite sides of the bore, wherein the apertures extend through at least a portion of the bore.

10. The key system of claim 9 wherein the projection comprises one or more notches.

11. The key system of claim 10 wherein the notches are inserted into the bore and the fasteners are inserted through the apertures such that the fasteners engage the notches and secure the projection within the bore.

12. The key system of claim 1 wherein the means for removably connecting the blank and the head together comprises a threaded portion of the projection.

13. The key system of claim 12 wherein the bore comprises a threaded surface adapted to matingly engage with the threaded portion of the projection.

14. The key system of claim 13 further comprising stabilizing means for preventing the blank from rotating relative to the head.

15. The key system of claim 1 wherein the projection further comprises one or more tabs that extend outward and are adapted for placement over the side surface of the head, wherein each tab comprises an aperture.

16. The key system of claim 15 wherein the head further comprises one or more apertures positioned adjacent the bore, such that when the projection is inserted into the bore the apertures of the tabs are aligned with the apertures of the head, and a fastener can be inserted through each of the apertures to secure the blank to the head.

17. An interchangeable key system comprising:
a non-spheroidal head having a one-piece construction, wherein the head comprises a side surface that spans the periphery, a top end, a bottom end that is opposite the top end, and a bore positioned within the side surface and at the bottom end;
a blank comprising a blade at a distal end and a projection at a proximal end; wherein the blade is adapted for insertion into a lock, and at least a portion of the projection is adapted for insertion into the bore; and
one or more fasteners adapted to secure the blank to the head.

18. The key system of claim 17 wherein the head further comprises a front surface and a back surface, and an aperture is positioned through the front surface near the bottom end, such that the aperture extends through a portion of the bore.

19. The key system of claim 18 wherein the projection is inserted into the bore a distance that extends at least as far as the aperture and the fastener is placed through the aperture such that the projection is secured within the bore.

20. The key system of claim 17 wherein the head further comprises one or more apertures positioned in the side surface and on opposite sides of the bore, wherein the apertures extend through at least a portion of the bore.

21. The key system of claim 20 wherein the projection comprises one or more notches.

22. The key system of claim 21 wherein the notches are inserted into the bore and the fasteners are inserted through the apertures such that the fasteners engage the notches and secure the projection within the bore.

23. The key system of claim 17 further comprising a collar, wherein the collar comprises a hollowed neck adapted to receive the projection and a support base that extends from the neck and is adapted to attach to the head.

24. The key system of claim 23 wherein the head comprises at least one aperture positioned generally adjacent to the bore and the support base comprises at least one aperture that aligns with the aperture in the head when the projection is inserted into the bore, such that the fastener can be inserted through the aperture in the support base and into the head to secure the collar to the head.

25. The key system of claim 23 wherein the projection is secured within the hollowed neck by attachment means such as adhesive, interference fit, welding, soldering, and/or brazing.

26. The key system of claim 17 wherein the fastener comprises a threaded portion of the projection.

27. The key system of claim 26 wherein the bore comprises a threaded surface adapted to matingly engage with the threaded portion of the projection.

28. The key system of claim 26 further comprising stabilizing means for preventing the blank from rotating relative to the head.

29. The key system of claim 17 wherein the projection further comprises one or more tabs that extend outward and are adapted for placement over the side surface of the head, wherein at least one tab comprises an aperture.

30. The key system of claim 29 wherein the head further comprises one or more apertures positioned adjacent to the bore, such that when the projection is inserted into the bore the apertures of the tabs are aligned with the apertures of the head, and the fastener can be inserted through each of the apertures to secure the blank to the head.

31. An interchangeable key system comprising:
a non-spheroidal head having a bore positioned in a side surface near the bottom;
a blank comprising a blade at one end and a projection at an opposite end; and
a collar comprising a hollowed neck adapted to be secured to the projection and a support base that extends from the neck and is adapted to attach to the head;
wherein the blank is secured to the head by inserting one or both of the projection and a portion of the collar into the bore and by attaching the support base to the head.

32. The key system of claim 31 wherein the head comprises at least one aperture positioned generally adjacent to the bore and the support base comprises at least one aperture that aligns with the aperture in the head when the projection or a portion of the collar is inserted into the bore, such that a fastener can be inserted through the aperture in the support base and into the head to secure the collar to the head.

33. The key system of claim 31 wherein the projection is secured within the hollowed neck by attachment means such as adhesive, interference fit, welding, soldering, and/or brazing.
